(19) United States
(12) Patent Application Publication
(10) Pub. No.: US 2013/0035117 A1
(43) Pub. Date: Feb. 7, 2013

(54) SYSTEM AND METHOD FOR RESTRICTING DRIVER MOBILE DEVICE FEATURE USAGE WHILE VEHICLE IS IN MOTION

(71) Applicants: Bakhtiar Brian LITKOUHI, Washington, MI (US); Donald K. Grimm, Utica, MI (US)

(72) Inventors: Bakhtiar Brian LITKOUHI, Washington, MI (US); Donald K. Grimm, Utica, MI (US)

(73) Assignee: GM GLOBAL TECHNOLOGY OPERATIONS LLC, Detroit, MI (US)

(21) Appl. No.: 13/198,176

(22) Filed: Aug. 4, 2011

(51) Int. Cl. H04W 4/04

(52) U.S. Cl. 455/456.4

(57) ABSTRACT

A method and system may determine one or more mobile devices associated with a driver of a vehicle. The method and system may deactivate, if one or more vehicle parameters indicate the vehicle is configured for motion, one or more features of the one or more mobile devices associated with the driver of the vehicle. The method and system may reactivate, if the one or more vehicle parameters indicate the vehicle is no longer configured for motion, the one or more features of the one or more mobile devices associated with the driver of the vehicle. The one or more mobile devices may, in some embodiments, be mobile telephones and the one or more features may be text entry features.

### FIELD OF INVENTION

The present invention is related to selectively restricting vehicle operator mobile device feature usage based on, for example, mobile device identification information, vehicle parameters, and other information.

### BACKGROUND OF THE INVENTION

Many mobile devices include features or applications which may require input and/or substantial attention from the user. Mobile device (e.g., cellular telephone) features, software, and/or applications may, for example, require text input from the user. Entering text into a mobile device and other features may require extended periods of attention and in particular visual attention (e.g., more than one second) from the user. Use of input and/or attention for mobile device features and applications while driving may, for example, divert a driver's attention from driving functions.

Some typical mobile device use restriction systems may, for example, limit driver use of predefined mobile device features and applications by disabling the applications when the mobile device and/or user are moving faster than a threshold speed (e.g., 20 miles per hour (mph)). Speed threshold based applications may disable the driver's mobile device features while driving, but may also unnecessarily disable vehicle passenger mobile device features. Other mobile device use restriction systems may limit the use of certain applications in mobile devices near a vehicle that is in motion. Vehicle motion based applications may be inefficient because features in all mobile devices within a predefined distance from the vehicle, including mobile devices associated with passengers and pedestrians near the vehicle, may potentially be restricted or deactivated.

### SUMMARY OF THE INVENTION

In some embodiments, a method and system may determine one or more mobile devices associated with a driver of a vehicle. The method and system may deactivate, if one or more vehicle parameters indicate the vehicle is configured for motion or in motion, one or more features of the one or more mobile devices associated with the driver of the vehicle. The method and system may reactivate, if the one or more vehicle parameters indicate the vehicle is no longer configured for or in motion, the one or more features of the one or more mobile devices associated with the driver of the vehicle. The one or more mobile devices may, in some embodiments, be mobile telephones, and the one or more features may be for example text entry features.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a mobile device feature deactivation system according to embodiments of the present invention;

FIG. 2 is a schematic illustration of a portion of a vehicle with a mobile device feature deactivation system according to embodiments of the present invention; and

FIG. 3 is a flowchart of a method according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. It will however be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that throughout the specification discussions utilizing terms such as “processing,” “computing,” “storing,” “determining,” “evaluating,” “calculating,” “measuring,” “providing,” “transferring,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Mobile device feature deactivation systems and methods may limit a vehicle operator (e.g., a driver) from using predetermined mobile device applications or features while driving. A mobile device application deactivation system may function via an application, software, and/or feature installed on one or more mobile devices or in another location. A signal may, for example, be sent to the mobile device from the system. The signal may, for example, be a short-range signal (e.g., Bluetooth® short-range wireless standard signal, Wi-Fi network signal or other signal) sent by an antenna associated with the system. The mobile device may receive the signal using an antenna or other device. Based on the signal, an application in the mobile device or other system may restrict use of mobile device features, applications, or functionality of the mobile device.

The system may restrict a driver's use of input based, user attention intensive, or other predefined mobile device features (e.g., e-mail, texting or text entry, text-based functions, camera, or other features), applications (e.g., text message, touchscreen entry based, and other applications), functions, games, and/or software which may divert the driver's attention from driving.

According to some embodiments, it may be determined that only one occupant is in the vehicle (e.g., only the driver is in the vehicle). The number of occupants in the vehicle may, for example, be determined by a system using an occupant detection device (e.g., an occupant detection sensor such as a camera, a seat occupant detector such as pressure or biometric sensor, or other device), the number of mobile devices (which were previously registered, pre-registered or known to the vehicle through pairing, etc), or using other methods or devices. If only the driver is in the vehicle, predetermined features of driver's mobile device may, for example, be deactivated or restricted when it is determined the vehicle is configured for motion (or a certain kind of motion) and/or when vehicle parameters indicate the vehicle is in motion. The predetermined features of driver's mobile device may be deactivated in response to a signal (e.g., a short-range or other signal) transmitted to mobile device over a network (e.g., a short-range network) from the system and/or the vehicle. The network may be, for example, a Bluetooth® short-range wireless standard network. OnStar® service connection, IEEE 802.15 wireless personal area network (PAN), Wi-Fi network, or other short-range communication network. The signal transmitted to the mobile device may, in some embodiments, define which mobile device features should be deactivated. The features may, in some embodiments, be reactivated, if vehicle parameters indicate the vehicle is no longer configured for motion (e.g., the gearshift is returned to or set to park position). The features may, for example, be reactivated by transmitting a signal to the mobile device.

According to some embodiments, it may be determined that multiple occupants (e.g., driver and one or more passengers) are in the vehicle. It may be determined by system which mobile device in a vehicle is registered to, owned by, or associated with the driver. Which mobile device is associated with the driver may be determined by for example using mobile device identification information (e.g., mobile device network address, profile or other information). For example, a driver may pair, register, or otherwise link her mobile device with the mobile device feature deactivation system, vehicle, or a computer associated with the vehicle. The driver may, in some embodiments, register or pair her mobile device to the system, vehicle or computer associated with the vehicle over a PAN, Bluetooth® network, OnStar® service connection, IEEE 802.15 wireless PAN, Wi-Fi network, or other short range communication network. Registration could also be accomplished using near field communications (NFC). Each mobile device registered or paired to the system may, for example, transmit mobile device identification information (e.g., a mobile network address), and it may be determined based on the identification information of the mobile devices registered to the network, which mobile device is associated with driver. The driver's mobile device may, for example, be determined based on one or more personalization settings associated with driver's mobile device. Once the driver's mobile device has been determined or discerned by system, predetermined features of the driver's mobile device may, for example, be deactivated when vehicle parameters indicate the vehicle is configured for motion. Other vehicle parameters may be used.

According to some embodiments, it may be determined that multiple mobile devices associated with multiple occupants are in the vehicle. Predefined features of all mobile devices in the vehicle may, in some embodiments, be deactivated when vehicle parameters indicate the vehicle is motion or configured for motion. A prompt to enter a code may be issued, broadcast, or transmitted to occupants. The prompt may, in some embodiments, instruct occupants not driving the vehicle (e.g., passengers) to perform an action to reactivate their mobile device. A passenger may, for example, respond to the prompt and reactivate features of their mobile device by entering a pass-code, personal identification number (PIN), or other code into a keypad, touch screen, or other device in vehicle. Predefined features of a mobile device may also be reactivated by actuation of an input switch, verbal command, or by other device. Other devices and systems may be used to deactivate, reactivate, or otherwise control the function of mobile device features.

According to some embodiments, a driver may use a mobile device to start or unlock the vehicle. A mobile device may start or unlock the vehicle by sending, emitting, or transmitting a cellular signal, radio frequency (RF) signal, near field communications (NFC) signal, or other signal to the vehicle or an antenna or receiver associated with the vehicle. Features of a mobile device used to start or unlock the vehicle may, for example, be deactivated while vehicle parameters indicate the vehicle is in motion or configured for motion.

A mobile device feature deactivation system and method according to embodiments may be useful because it may selectively deactivate features in one mobile device the driver's mobile device) in a vehicle while not deactivating other mobile devices. By not deactivating features in all mobile devices in a vehicle, passenger mobile device functionality may not be affected. By not deactivating features of passenger mobile devices, mobile device users may be less inclined to uninstall, remove, or other otherwise attempt to circumvent the mobile device feature deactivation system.

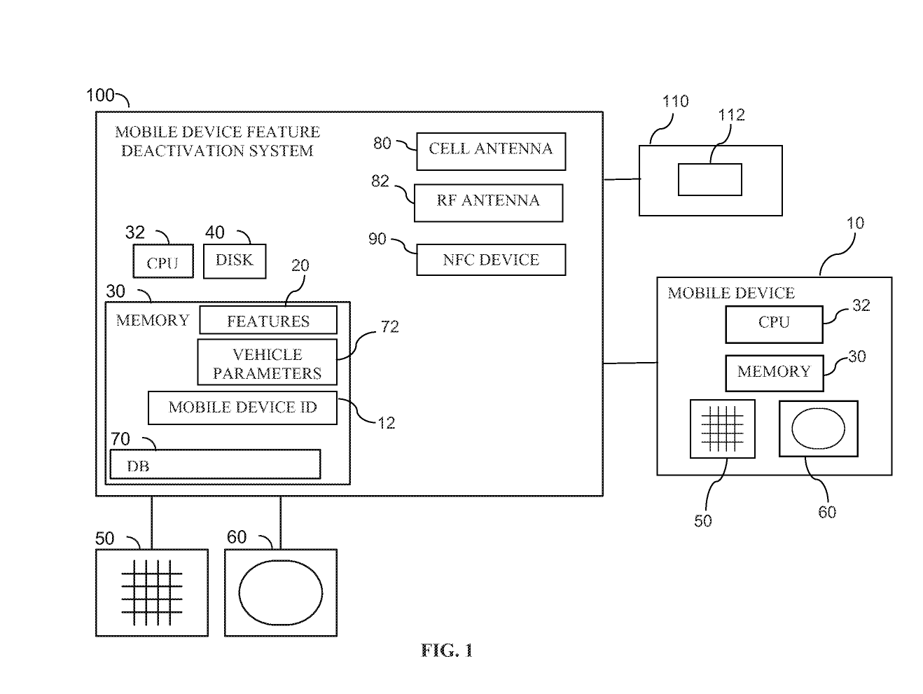

FIG. 1 is a schematic illustration of a mobile device feature deactivation system according to embodiments of the present invention. Mobile device feature deactivation system 100 may include or be associated with one or more mobile devices or handheld computers 10 (e.g., a cellular telephone, tablet computer, portable computer, laptop computer, personal digital assistant (PDA), portable gaming device, handheld computer or other device). System 100 may, in some embodiments, be a part of or be associated with vehicle 110, a computer 112 associated with vehicle 110, or another device.

Mobile device 10 may include one or more, applications, programs, functions, software and/or features 20. Features 20 may, for example, include data messaging (e.g., text message, short message service (SMS), mobile instant messaging (MIM), picture message, e-mail), gaming (e.g., action, sports, puzzles, card games, etc.), camera, video, reading (e.g., digital books) and/or other types of features or applications. Some features 20 may, for example, require input, focus, and/or, attention from a mobile device user.

Mobile device feature deactivation system 100, mobile device 10, and/or computer 112 associated with vehicle may include one or more processor(s) or controller(s) 32, memory 30, long term storage 40, input device(s) or area(s) 50, and output device(s) or area(s) 60. Input device(s) or area(s) 50 may be, for example, a touch screen, a capacitive input device, a keyboard, a keypad, number pad, microphone, pointer device, a button, a switch, stylus, and/or other device. Output device(s) or area(s) 50 may be, for example, a display, screen, audio device (e.g., a speaker, ear piece, headset, Bluetooth headset, or headphones), or other device. Input device(s) or area(s) 50 and output device(s) or area(s) 60 may be combined into, for example, a touch screen display and input, which may be part of system 100 and/or mobile device 10.

System 100 and/or mobile device 10 may include one or more databases 70. Databases 70 may be stored all or partly in one or all of long-term storage 40, memory 30, or another device. Memory 30 may include features, applications, programs, vehicle parameters 72 (e.g., gearshift position, transmission mode, vehicle speed, or other information indicating whether vehicle is configured for motion or in motion), mobile device identification information 12 (e.g., mobile device network address, mobile device pairing profile, identification key, or other information), information (e.g., telephone numbers, music, e-mail, mobile device network address(es)), and/or other forms of data.

System 100 and/or mobile device 10 may include one or more antennas. System 100 may, in some embodiments, include a cellular antenna 80, radio frequency (RF) antenna 82, or another type of antenna or other device to send and/or receive signals. Cellular antenna 80 may, in some embodiments, may include an RF antenna 82 or RF antenna functionality. Cellular antenna 80, RF antenna 82, another antenna, or another device may transmit information from or to system 100, mobile device 10, vehicle 110, computer 112 associated with vehicle, or other device. Cellular antenna 80, RF antenna 82, or another antenna or device may, in some embodiments, be operable to start vehicle 110.

System 100 and/or mobile device 10 may be or may include a near field communication (NFC) device 90. NYC device 90 may transfer information between system 100 and/or mobile device 10 and a vehicle 110, computer 112 associated with vehicle, another mobile device, or other device. NFC device 90 may, in some embodiments, be operable to start or unlock vehicle 110.

Processor or controller 20 may be, for example, a central processing unit (CPU), a chip or any suitable computing or computational device. Processor or controller 20 may include multiple processors, and may include general purpose processors and/or dedicated processors such as graphics, audio and/or video processing chips. Processor 20 may execute code or instructions, for example, stored in memory 30 or long term storage 40, to carry out embodiments of the present invention.

Memory 30 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 30 may be or may include multiple memory units.

Long term storage 40 may be or may include, for example, a hard disk drive, a floppy disk drive, a Compact Disk (CD) drive, a CD-Recordable (CD-R) drive, a universal serial bus (USB) device or other suitable removable and/or fixed storage unit, and may include multiple or a combination of such units.

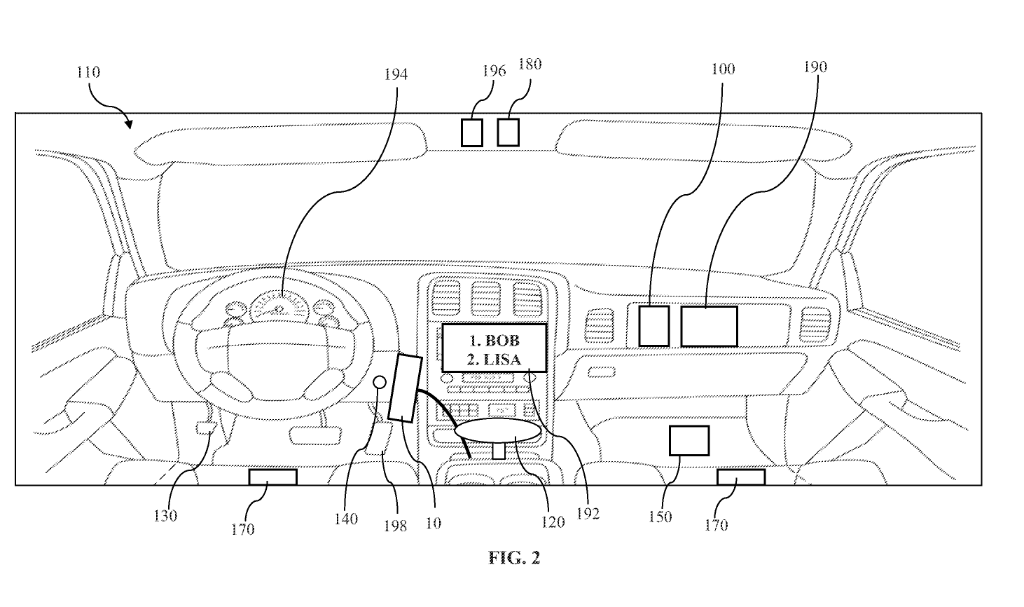

FIG. 2 is a schematic illustration of a portion of a vehicle with a mobile device feature deactivation system according to embodiments of the present invention. Vehicle 110 (e.g. an automobile, truck, motorcycle, plane, boat, etc.) may include and/or be associated with a mobile device feature deactivation system 100 and/or a part of system 100. System 100 or part of system 100 may, in some embodiments, be included in vehicle 110. System 100 and/or components of system 100 may, in some embodiments, be located exterior to vehicle 110, exterior to mobile device 10 in a remote server, in the cloud, and/or in another location.

According to some embodiments, mobile devices 10 may, for example, be in the possession of registered to, used by, or associated with one or more occupants in vehicle 110. For example, a person may be associated with a cellular telephone by being listed by a cellular provider as the owner of or subscriber for the telephone. System 100 may restrict a driver's use of input based, user attention intensive, or other predefined mobile device features 20 (e.g., text entry, text message applications, touchscreen entry based, and other applications, e-mail, camera(s), games, or other features), functions, games, and/or software that may divert the driver's attention from driving. System 100 may, for example, limit features and/or functions 20 within applications or features 20 of mobile device 10. For example, text entry functions (e.g., keypad, keyboard, or touchscreen data entry or other text entry functions) of one or more features or applications 20 in mobile device 10 may, for example, be disabled or restricted while voice input (e.g., voice data entry, speech to text, etc.), hands-free data entry, data output features (e.g., displaying text, pictures, video, etc.), and other functions are not restricted. A user may, in some embodiments, be restricted from using a scrolling feature in an e-mail application while still being able to view the e-mail subject, sender, and other information. System 100 may, therefore, selectively limit, deactivate, delimit, restrain, and/or restrict the use of one or more mobile device features 20 of a driver's mobile device 10 based on a vehicle parameters 72, state, status, and/or other information related to vehicle 10.

According to some embodiments, pre-defined mobile device output features 20 may be restricted, disabled, or disengaged while vehicle 110 is configured for motion. For example, a mobile device 10 associated with a driver may receive text message(s), e-mail(s), notification(s) (e.g., from applications or other sources), and/or other information while vehicle 110 is configured for motion. The received text message(s), e-mail(s), notification(s), and/or other information may, in some embodiments, not be displayed to the driver while vehicle 110 is configured for motion and may be suppressed, saved and/or displayed to driver when vehicle 110 is no longer configured for motion or at another time. For example, text message(s), e-mail(s), notifications, and other information received while driver is driving vehicle 110 may be displayed to the driver when vehicle is parked after driving, when vehicle parameters 72 indicate vehicle 110 is no longer configured for motion, or at another time.

According to some embodiments, system 100 may, for example, restrict use of mobile device 10 features when vehicle parameters 72 indicate that vehicle 110 is configured for movement or is in motion. Vehicle parameters 72 may, for example, describe the position of vehicle gearshift 120 (e.g., the gearstick, gear lever, selection lever, shift stick and/or gear shifter); automatic, manual, or other transmission mode 194 (e.g., park, drive, reverse, etc.); or other vehicle parameters. Gearshift 120 may, for example, in an automatic transmission vehicle 110 be configured for movement or motion (or deemed to be configured for motion) if the gearshift 120 or transmission mode 194 is in the drive, neutral, reverse, low, or other non-park position, setting, or configuration. Gearshift 120 may, in some embodiments, be configured for motion if the transmission mode or gear 194 is not in or set to park. System 100 may, in some embodiments, measure vehicle parameters associated with movement of a vehicle (e.g., gearshift 120 position or setting) to determine whether vehicle is configured for motion. Other vehicle parameters may be used.

According to some embodiments, in a vehicle 110 with a manual transmission, vehicle 110 may be configured for movement or motion (or deemed to be configured for motion) if parking brake 130 is not engaged or activated, transmission mode or gear 194 indicates vehicle is configured for motion (e.g., manual transmission mode 194 is not in neutral setting), wheel speed is above a predefined threshold, engine or motor torque is above a predefined threshold, accelerator or gas pedal 198 position indicates vehicle is in motion, and/or a global positioning system (GPS) associated with vehicle 110 indicates vehicle is in motion. In some embodiments, manual transmission vehicle 110 may be configured for motion if ignition 140 has been started. Vehicle ignition 140 may, for example, be started be a vehicle key, remote key, mobile device 10, cell telephone, or other device. Other vehicle parameters may be used. Configured for motion may mean that a setting, such as a gear or mode selector, is selected such that a driver may cause the car to move by pressing on the accelerator or gas pedal 198, or in other embodiments, if a parking brake 130 is not engaged. In some embodiments, it may be determined based on a combination of vehicle parameters 72 (e.g., vehicle ignition 140 and transmission gear 194, accelerator position 198 and transmission gear 194, etc.) whether vehicle 110 is configured for motion.

According to some embodiments, one or more mobile devices 10 may, for example, be registered to, associated with, possessed by, and/or owned by one or more occupants of vehicle 110. Mobile devices 10 may, in some embodiments, transfer information to and receive information from a computer 112 associated with vehicle 110. Mobile device 10 may, in some embodiments, use cellular antenna 80, RF antenna 82, or another device to send signals to, transmit information to, or communicate with system 100, computer 112 associated with vehicle 110, or another device. Vehicle 110 or computer 112 may receive signals from mobile device 10 via an antenna 160 or another device associated with vehicle 110. Computer 112 may, in some embodiments, be a component of system 100 or another device associated with vehicle 110.

According to some embodiments, system 100 or computer 112 associated with vehicle 110 may, for example, transfer and receive information from mobile device 10 over a personal area network (PAN), Onstar® network, a Wi-Fi network, short-range wireless network, local area network (LAN), Bluetooth® short-range wireless standard network, IEEE 802.15 wireless personal area network (PAN), or other type of network. Mobile devices 10 may include open wireless technology functionality (e.g., Bluetooth® and/or other functionality).

Mobile devices 10 registered to one or more occupants of vehicle 110 may, in some embodiments, be paired to, registered to, or otherwise communicate in a network with system 100, vehicle 110 and/or computer 112 associated with vehicle 110. Pairing mobile device 10 to vehicle 110 may create a secure and/or exclusive network between mobile device 10 and computer 112 associated with vehicle 110. When mobile device 10 pairs to computer 112 associated with vehicle 110, mobile device 10 may transfer, register, or otherwise communicate mobile device identification information 12 (e.g., network address, identification key, or other information) to computer 112. Mobile device identification information 12 may, for example, be used by computer 112 to distinguish one mobile device 10 from other mobile device(s) 10, establish a secure network between computer 112 and mobile device, and/or other functions.

According to some embodiments, system 100 may determine the number of occupants in vehicle 110. System 100 may, for example, determine the number of occupants using occupant detection sensors 170 (e.g., seat occupant detector, weight sensor, dashpot, or other device associated with one or more vehicle seat(s)), cameras 196, or other device(s). System 100 may, in some embodiments, determine the number of occupants in vehicle 110 by determining the number of mobile device(s) 10 paired to, previously paired to, previously registered to, and/or communicating with computer 112 and/or system 100. Other methods, systems, and devices may be used by system 100 to determine the number of occupants in vehicle.

According to some embodiments, if system 100 determines that the driver is the only occupant of the vehicle (e.g., no passengers are detected), system 100 may deactivate features 20 of the driver's mobile device 10. Driver's mobile device 10 may, for example, be paired to, registered to a PAN with, registered to a LAN with, or otherwise communicate with vehicle communication computer 112 and/or system 100. System 100 may, in some embodiments, deactivate features 20 of mobile device 10 while vehicle parameters 72 indicate vehicle 110 is configured for or in motion. Predetermined features 20 of driver's mobile device 10 may be deactivated in response to a signal transmitted aver a network from system 100, computer 112, vehicle 110 to mobile device 10 (e.g., via cellular antenna 80, RF antenna 82 or other device). The signal may, for example, be a cellular signal sent by antenna 160 associated with system 100. Mobile device 10 may receive the signal using an antenna (e.g., cellular antenna 80, RF antenna 82, or other antenna) or other device (e.g., NFC device 90). Based on the signal, an application in mobile device 10 or other system may restrict use of mobile device features, applications, or functionality 20 of mobile device 10.

According to some embodiments, system 100 may deactivate predefined features 20 of all mobile devices 10 in vehicle 110 or, in some embodiments, all mobile devices 10 paired to vehicle computer 112 and/or system 100. System 100 may, in some embodiments, prompt vehicle passengers, but not the driver, to re-activate mobile device features 20 by, for example, entering a code, pass-code, personal identification number (PIN), or other input into a keypad 190 (e.g., a keypad, number pad, touchscreen, or other input device), input device 50, or other type of device associated with system 100, vehicle 110, computer 112, or other device. System 100 may, for example, prompt occupants to enter a code or provide a response if the occupant is not the driver of the vehicle (e.g., a passenger). If a passenger enters the code or otherwise provides a response, system 100 may reactivate the passenger's mobile device 10 by sending a signal including instructions, commands or information to mobile device 10. The passenger's mobile device 10 may receive the signal and an application on mobile device 10 or other system may reactivate features of mobile device 10 based on the instructions in the signal from system 100.

System 100 may, in some embodiments, ask occupants via an audio message from a speaker 194 or other device a challenge question, statement, or prompt (e.g., “please enter a code if you are not driving” (where the code may be provided by the prompt), “please enter your telephone number if you are not driving”, “please say your telephone number if you are not driving,” etc). Passengers may, in some embodiments, respond to the challenge question with a verbal response into a microphone 194 associated with vehicle 110. If passengers are prompted to reply with a verbal response into a microphone 194, it may, however, be easy for a driver to circumvent the system. Passengers may, in some embodiments, be prompted to respond to the challenge question by entering information (e.g., PIN, telephone number, or other information) into a keypad 190, input device 50, or other input device or providing another response. If a passenger enters information or otherwise provides a response, system 100 may reactivate the passenger's mobile device or handheld computer 10 by sending a signal including instructions, commands or information to mobile device 10. The passenger's mobile device 10 may receive the signal and an application on mobile device 10 or other system may reactivate features of mobile device 10 based on the instructions in the signal from system 100. It may, however, be difficult for the driver to enter information into a keypad 190 while vehicle 110 is in motion (e.g., keypad 190 may be out of the driver's reach or it would require skill and timing to enter information while driving). A driver's use of certain or predefined mobile device features 20 may, therefore, be restricted while vehicle 110 is in motion.

According to some embodiments, system 100 may include a display 192 (e.g., output device 60 and/or other device) to display information. Display 192 may, for example, display a list of mobile devices 10 that are currently paired to, registered to a network with, or otherwise communicating with vehicle computer 112 and or system 100. Display 192 may, in some embodiments, list one or more mobile device(s) 10 whose input, text input, and/or other features have been disabled. Display 192 may include touch input functionality or may be associated with keypad 190, which may allow occupants to re-engage, reactivate, and/or activate input based mobile device 10 features.

System 100 may, in some embodiments, determine which mobile device 10 is associated with the driver of vehicle 110 based mobile device 10 identification information 12 (e.g., pairing profile, mobile device network address, profile, personalization settings, or other information). In such an embodiment it may be known or assumed beforehand which mobile device or devices 10 are typically associated with the driver(s) of this particular vehicle 110. Driver's mobile device 10 and other mobile devices 10 may, for example, be paired to, registered to a PAN with, registered to a LAN with, or otherwise communicate with vehicle communication computer 112 and/or system 100. Mobile device 10 associated with the driver may, in some embodiments, be registered to, communicate with, or paired to system 100 or computer 112 associated with the vehicle 110 over a PAN, Bluetooth® network, OnStar® service connection, IEEE 802.15 wireless PAN, Wi-Fi network, NFC network, or other short range communication network. Each mobile device 10 paired to system 100 may, for example, transmit mobile device identification information 12 (e.g., pairing profile, mobile network address, personalization settings or other information) to system 100, computer 112, or another device. It may be determined based on identification information 12 of mobile devices 10 registered to the network, which mobile device 10 is associated with driver. The driver's mobile device 10 may, in some embodiments, be determined based on one or more personalization settings associated with driver's mobile device. Once the driver's mobile device 10 has been determined or discerned by system 100, predetermined features 20 of the driver's mobile device 10 may, for example, be deactivated when vehicle parameters 72 indicate the vehicle 110 is configured for motion. Other vehicle 110 or mobile device 10 parameters may be used to determine the driver of vehicle 110.

System 100 may, in some embodiments, determine from prior vehicle usage, which mobile device 10 among multiple mobile devices is associated with the driver by, for example, calculating or determining the percentage and/or likelihood that each occupant is the driver. System 100 may determine the likelihood that an occupant is the driver based on prior vehicle usage by, for example, calculating the number of times a given occupant's mobile device 10 has been paired with vehicle 110 or computer 112 and comparing the number of previous pairings to the total pairings.

One of the occupants in vehicle 110 may, for example, be determined by system 100 to be the driver of the vehicle 90 percent (%), or another percentage of time, and may be deemed the primary driver. For example, one occupant may own vehicle 110 and may be the primary driver of vehicle 110 but may occasionally allow others to drive the vehicle 110. System 100 may, in some embodiments, assume that when the primary driver is in vehicle 110, that primary driver is the driver. If other occupants are in vehicle 110 with primary driver, system 100 may output a challenge signal, verification signal, or other type of signal (e.g., an audible signal, light signal, or other type of signal) to the primary driver and/or other occupants requesting verification that primary driver or another occupant is driving vehicle 110. System 100 may, for example, output an audio signal through a speaker 180 requesting that the primary driver verify whether or not they are driving vehicle 110. System 100 may, in some embodiments, output an audio request that the occupant driving identify themselves (e.g., by entering or stating their telephone number or another response).

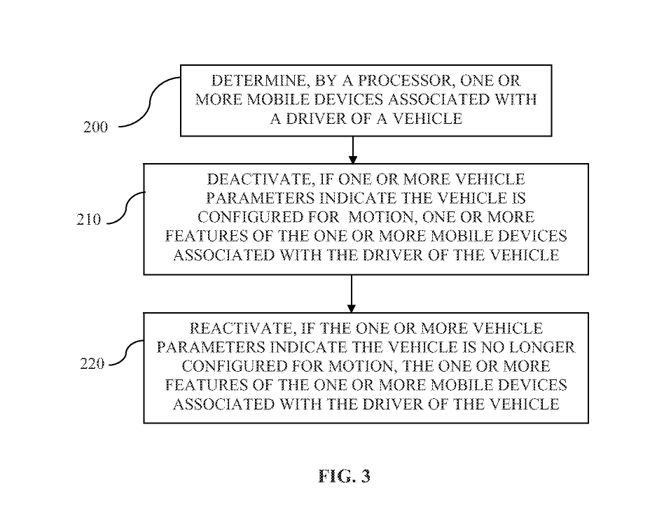

FIG. 3 is a flowchart of a method according to embodiments of the present invention. In operation 200, one or more mobile devices (e.g., mobile device 10 of FIG. 2) associated with a driver of a vehicle (e.g., vehicle 110 of FIG. 2) may be determined. One or more mobile devices may, in some embodiments, be cellular telephones, mobile telephones, tablet computers, or other mobile devices.

In operation 210 if one or more vehicle parameters (e.g., gearshift 120 position of FIG. 2) indicate the vehicle is in motion or configured for motion, one or more features (e.g., features 20 of FIG. 1) of the one or more mobile devices associated with the driver of the vehicle may be deactivated. One or more features may, in some embodiments, be data messaging features (e.g., text messaging, e-mail, etc.), text entry functions of applications or features, gaming features, or other mobile device features. The one or more features of the one or more mobile devices associated with the driver of the vehicle may be deactivated by sending a signal to the mobile devices, the mobile device receiving the signal, and deactivating the one or more features of the mobile devices based on the signal.

In operation 220, if the one or more vehicle parameters transmission mode 192 of FIG. 2) indicate the vehicle is no longer configured for motion, the one or more features of the one or more mobile devices associated with the driver of the vehicle may be reactivated. Vehicle may, in some embodiments, be no longer configured for motion if the transmission mode (e.g., transmission mode 194 of FIG. 2), gearshift (e.g., gearshift 120 of FIG. 2) or other device is in the park position or is set to park. The one or more features of the one or more mobile devices associated with the driver of the vehicle may be reactivated by sending a signal to the mobile devices, the mobile device receiving the signal, and reactivating the one or more features of the mobile devices based on the signal.

Other or different series of operations may be used.

Embodiments of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments of the invention may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A method comprising:
determining, by a processor, one or more mobile devices associated with a driver of a vehicle; and
deactivating, if one or more vehicle parameters indicate the vehicle is configured for motion, one or more features of the one or more mobile devices associated with the driver of the vehicle.

2. The method of claim 1, wherein the one or more vehicle parameters comprise a gearshift position and the one or more vehicle parameters indicate the vehicle is configured for motion if the gearshift is not in the park position.

3. The method of claim 1, wherein the one or more mobile devices comprise one or more mobile telephones.

4. The method of claim 1, wherein determining, by the processor, the one or more mobile devices associated with the driver of the vehicle comprises determining, based on the mobile device identification information of the one or more mobile devices paired to a computer associated with the vehicle, the mobile device associated with the driver.

5. The method of claim 1, wherein determining the one or more mobile devices associated with the driver comprises determining a mobile device used to start the vehicle.

6. The method of claim 1, wherein deactivating, if the one or more vehicle parameters indicate the vehicle is configured for motion, the one or more features of the one or more mobile devices associated with the driver of the vehicle comprises:
sending a signal to the one or more mobile devices;
receiving, by the one or more mobile devices, the signal; and
deactivating the one or more features of the mobile devices based on the signal.

7. The method of claim 1, comprising reactivating, if the one or more vehicle parameters indicate the vehicle is no longer configured for motion, the one or more features of the one or more mobile devices associated with the driver of the vehicle.

8. The method of claim 1, wherein the one or more features comprise one or more text entry functions of one or more features in the one or more mobile devices.

9. A system comprising:
a memory;
a processor to:
determine one or more mobile devices associated with the driver of the vehicle; and
deactivate, if one or more vehicle parameters indicate the vehicle is configured for motion, one or more features of the one or more mobile devices associated with the driver of the vehicle.

10. The system of claim 9, wherein the one or more vehicle parameters comprise one or more gearshift positions and the one or more vehicle parameters indicate the vehicle is configured for motion if the gearshift position is not in the park position.

11. The system of claim 9, wherein to deactivate, if the one or more vehicle parameters indicate the vehicle is configured for motion, the one or more features of the one or more mobile devices associated with the driver of the vehicle the processor is to send a signal to the one or more mobile devices.

12. The system of claim 9, wherein the processor is to determine the one or more mobile devices associated with the driver of the vehicle based on the mobile device identification information of the one or more mobile devices registered to a personal area network with a computer associated with the vehicle.

13. The system of claim 9, wherein to determine one or more mobile devices associated with the driver of the vehicle the processor is to determine the one or more mobile devices used to unlock the vehicle.

14. The system of claim 9, to deactivate, if the one or more vehicle parameters indicate the vehicle is configured for motion, the one or more features of the one or more mobile devices associated with the driver of the vehicle the one or more mobile devices are to:
receive a signal; and
deactivate the one or more features based on the signal.

15. A method comprising:
measuring, by a controller, one or more vehicle parameters associated with movement of a vehicle;
deactivating, if the one or more vehicle parameters indicate the vehicle is configured for movement, one or more applications on the one or more handheld computers associated with one or more vehicle occupants;
prompting the one or more vehicle occupants associated with the handheld computers to enter information into an input device associated with the controller; and
reactivating the one or more applications on the handheld computer associated with a vehicle occupant, if the vehicle occupant enters the information into the input device.

16. The method of claim 15, wherein the one or more handheld computers comprise one or more cellular telephones.

17. The method of claim 15, wherein the one or more vehicle parameters comprise a transmission mode and the vehicle parameters indicate the vehicle is configured for movement if the transmission mode is not set to park.

18. The method of claim 15, wherein the one or more applications comprise data messaging applications.

19. The method of claim 15, wherein prompting the one or more vehicle occupants associated with the handheld computers to enter information into an input device associated with the controller comprises prompting the occupant to enter a code if the occupant is not a driver of the vehicle.

20. The method of claim 15, wherein reactivating the one or more applications on the handheld computer associated with the vehicle occupant, if the vehicle occupant enters the information into the input device comprises:
sending a signal to the handheld computer;
receiving, by the handheld computer, the signal; and
reactivating the one or more applications on the handheld computer based on the signal.
